(19) United States
(12) Patent Application Publication
(10) Pub. No.: US 2003/0067922 A1
(43) Pub. Date: Apr. 10, 2003

(54) Communication method, communication device, and communication terminal

(76) Inventor: Norifumi Yoshitani, Nabari-shi (JP)

Correspondence Address: BIRCH STEWART KOLASCH & BIRCH, PO BOX 747, FALLS CHURCH, VA, 22040-0747, US

(21) Appl. No.: 10/247,545

(22) Filed: Sep. 20, 2002

(30) Foreign Application Priority Data
Sep. 21, 2001 (JP) P2001-289799

(51) Int. Cl. H04L 12/28

(52) U.S. Cl. 370/394; 370/412

(57) ABSTRACT

An object of the present invention is to provide communication methods, communication devices, and communication terminals that are capable of improving the quality of recorded voice in a case where sound information is communicated over the Internet. A delay packet that is delayed within the Internet is discarded and not reproduced, and in place of the lost voice packet, a supplementary packet is created using data extrapolated from the packets before and after it, and is reproduced. The packet that is not reproduced is stored in the record buffer of a storage device along with the other packets, and when reproducing voice after reception is complete, such as in the case of reproducing recorded voice, all received packets are arranged in a predetermined order based on their detected sequence number and reproduced.

### BACKGROUND OF THE INVENTION

1. Field of the Invention

The present invention relates to a communication method, a communication device, and a communication terminal for communicating sound information such as voice over the Internet.

2. Description of the Related Art

With methods of transferring sound information such as voice in packets using an IP (Internet Protocol), in the case of conventional communication via telephone, the farther away a call is placed, the greater the expensive involved. Particularly in the case of international telephone calls, calls are expensive and generally made less frequently for shorter times, the longer the distance involved. However, when voice is communicated via the Internet, the cost of the call is covered by the communication fee of a regular local call from the terminal to the access point, and therefore calls can be made at extremely low rates. Accordingly, advances are being made in a method called VoIP (Voice over Internet Protocol) for transferring voice over the Internet. However, when voice is transmitted over the Internet in packets, the transmission time from the transmitter terminal of the packets to the receiver terminal differs depending on the packet, and in real time communications such as speech, when late arriving delay packets do not arrive in time for reproduction and thus voice cannot be reproduced in real time, for example, a portion of the packets is discarded and interpolated with suitable data such as noise. This, however, poses a significant problem because the quality of the sound is deteriorated.

With the terminal device of the speech communication system disclosed in Japanese Unexamined Patent Publication JP-A 9-172459 (1997), the usage rate of the network when data including at least voice data are transferred over a computer network is determined, and the sampling frequency or the compression format of the voice compression circuit is changed to correspond the usage rate on the computer network. Consequently, favorable communication can be performed with good sound quality and no breaks in the sound even when the computer network is congested.

With the voice encoding and transmission technology disclosed by Japanese Unexamined Patent Publication JP-A 10-105193 (1998), voice information can be preliminarily listened to on the receiving side without any wait time even over a slow-speed transfer route. As a result of this preliminary listening, also when the user wishes to hear the same voice information again at high quality, the voice information can be heard in high quality with minor waiting times. The transmission portion splits an encoded output obtained by encoding a voice input signal with a scalable encoder into abbreviated data with a low bit rate that can be transferred in real time and detailed data for reproducing the voice signal in high quality in combination with the abbreviated data. The data transfer portion transfers the abbreviated data collectively, ahead of the detailed data, and then transfers the detailed data collectively. The receiver portion sequentially decodes the received abbreviated data without waiting for the detailed data to be received and reproduces the voice signal in real time. Accordingly, the data can be listened for general understanding. When the receiver portion receives both the abbreviated data and the detailed data, it synthesizes the two and reproduces the voice signals in high quality.

A communication system disclosed in Japanese Unexamined Patent Publication JP-A 10-164129 (1998) includes a transmission station for packetizing voice information that is transmitted from the telephone on the transmitting side and sequentially transmitting these packets to a telephone on the receiving side via the Internet, and a receiver station for receiving the packets that are transmitted from the transmission station and sequentially transmitting the voice information included in the packets to a telephone on the receiving side. In this system, the transmission delay time representing the delay in transmission of the voice information included in the packets from the receiver station to the telephone on the receiving side is measured, and based on the transmission delay time, a portion of the voice information is deleted. Consequently, delays in transmitting the voice information to the receiver terminal can be kept from building up even if voice communications are connected over a packet communication network.

A communication system disclosed in Japanese Unexamined Patent Publication JP-A 10-210074 (1998) includes a transmission station for turning voice frame data generated based on voice transmitted from the telephone on the transmitting side into IP packets and sequentially transmitting the IP packets to the telephone on the receiver side via the Internet, and a receiver station for receiving the IP packets that are transmitted from the transmission station and sequentially transmitting the voice that is generated based on the voice frame data included in the IP packets to the telephone on the receiving side. In this system, the receiver station is provided with a buffer memory for temporarily storing the IP packets received from the transmission station and means for restricting output from the buffer memory so that a predetermined number of voice frames are stored in the buffer memory. Thus, the quality of the reproduced voice in the receiver terminal can be maintained in the case where voice communications are connected over a packet communication network.

A real time voice communication device disclosed in Japanese Unexamined Patent Publication JP-A 11-150562 (1999) includes, in addition to a conventional voice communication device, a received packet management table for storing the number of received packets that are disregarded on the receiving side when data is received from a network, and a network input/output management portion for referencing the received packet management table, determining whether to discard received packets based on the number of packets received immediately after the voice data starts to be received, and in the case where a packet is not a discard packet, storing the received data in an output buffer and notifying reception of the voice data to a voice output portion. Thus, by discarding an arbitrary number of received packets immediately after communication starts, it is possible to achieve the real time communication of voice in high quality.

In a method of compensating for delay-sensitive data disclosed in Japanese Unexamined Patent Publication JP-A 2000-78202 (2000), delay-sensitive data are converted into first and second versions. This method compensates for transmission delays that occur during transfer of the second version and supplements the data to be reproduced using the data that are reproduced from the first version. Therefore, voice can be communicated over a data network with sufficient quality and reliability. Different compression formats are employed for the first and second versions.

In a buffer control method for communicating voice in real time according to Japanese Unexamined Patent Publication JP-A 2000-295286 (2000), the amount of data stored in the receive buffer is observed by the reproduction control module, and when it exceeds a threshold value, the buffer output is turned to be high-speed data by decimating the packets by a high-speed reproduction module to reduce the stored amount of data in the buffer and shorten the delay time. When the stored amount is less than the threshold value, the high-speed reproduction module is bypassed and the output of the receive buffer is reproduced at normal speed. Thus, packet loss and sound loss do not occur, even when there is network jitter.

In the method of routing during packet transfer that is disclosed by Japanese Unexamined Patent Publication JP-A 2000-278313 (2000), the generation of delays during routing is suppressed for each application. A configuration including elements from a packet storage portion to a routing search portion is provided, and an application corresponding to the transfer of input packets is identified and the timer value that has been assigned to the identified application in advance is analyzed. In the case where the port to transfer to is set based on an address stored in the routing table and the observed timer value is exceeded and routing does not end, then packets are discarded corresponding to the identified application program or packets are transferred over a predetermined route. In particular, packets are discarded when a delay time, such as a delay exceeding 100 milliseconds, for carrying out voice transfer in real time occurs during Internet telephony, for example, and communication over the telephone is not clear.

In communicating sound information composed primarily of voice via the Internet, when it is difficult to hear voice information during a speech communication or the like communicated in real time, then one can ask to hear it again. However, voice that has been recorded cannot be repeated. Therefore, the quality of the voice is very important, and it is necessary to record the voice clearly. However, a problem that arises with conventional is that the quality of recorded voice is poor because delay packets are discarded, for example.

### SUMMARY OF THE INVENTION

It is an object of the present invention to provide a communication method, a communication device, and a communication terminal that are capable of improving the quality of recorded voice when sound information is communicated over the Internet.

The present invention is directed to a communication method for communicating sound information in packets using an Internet protocol, wherein when reproducing packetized sound information at the same time it is received, a delay packet that is delayed during speech communication is discarded so as to reproduce the sound information, and when reproducing the packetized sound information after reception thereof is complete, all received packets, including the delay packet, are arranged in a predetermined order so as to reproduce the sound information.

According to the invention, when reproducing the packetized sound information at the same time it is received, a delay packet that is delayed during communication is discarded so as to reproduce the sound information, and when reproducing the packetized sound information after reception thereof is complete, all packets that are received, including the delay packet, are arranged in a predetermined order so as to reproduce the sound information. Thus, sound can be reproduced clearly, even if the sound information is difficult to hear during speech communication where the sound information is reproduced at the same time it is received, and the quality of recorded voice can be improved.

In another aspect, the invention is directed to a communication device for communicating sound information in packets using an Internet protocol, including storage means for storing packets of sound information that are received, and reproduction means for discarding a delay packet that is delayed during communication so as to reproduce the sound information when reproducing the packetized sound information at the same time it is received, and for arranging all packets that are stored in the storage means, including the delay packet, in a predetermined order so as to reproduce sound information when reproducing the packetized sound information after reception thereof is complete.

According to the invention, when reproducing the packetized sound information at the same time it is received, a delay packet that is delayed during communication is discarded so as to reproduce the sound information, and when reproducing the packetized sound information after reception thereof is complete, all packets that are stored in the storage means, including the delay packet, are arranged in a predetermined order so as to reproduce the sound information. Thus, sound can be reproduced clearly, even it the sound information is difficult to hear during speech communication where the sound information is reproduced at the same time it is received, and the quality of recorded voice can be improved.

In one embodiment, the invention includes selection means with which a user selects whether to operate the reproduction means.

According to the invention, the user can select whether to operate the reproduction means, so that the reproduction process can be changed to match the intent of the user.

In another embodiment, the invention includes specification means with which the user specifies, during reproduction of sound information at the same time it is received, or after reproduction has ended, a portion of the packets stored in the storage means to be arranged in a predetermined order for reproduction.

According to the invention, the user specifies, during reproduction of sound information at the same time it is received or after reproduction has ended, a portion of the packets stored in the storage means to be arranged in a predetermined order for reproduction, so that during speech communication, the other party can be put on hold, and after communication is over, the sound information of a specified portion can be reproduced in clear sound.

In still another embodiment of the invention, the storage means stores received sound information in predetermined blocks, and the specification means specifies the block.

According to the invention, the sound information is stored in predetermined blocks, and the user specifies the block for reproduction, so that a portion the user wishes to reproduce can be easily specified and reproduced.

In yet another embodiment of the invention, the storage means stores received sound information at predetermined times, and the specification means specifies the time.

According to the invention, sound information is stored at predetermined times, and the user specifies the time for reproduction, so that a portion the user wishes to reproduce can be easily specified and reproduced.

In an aspect, the invention is directed to a communication terminal connected to a telephone and communicating sound information in packets using an Internet protocol, including storage means for storing packets of sound information that are received, and transmission means for discarding a delay packet that is delayed during communication so as to transmit the sound information to the telephone, when transmitting the packetized sound information at the same time it is received, and for arranging all packets that are stored in the storage means, including the delay packet, in a predetermined order so as to transmit the sound information to the telephone, when transmitting the packetized sound information after reception thereof is complete.

According to the invention, when transmitting the packetized sound information at the same time it is received, a delay packet that is delayed during communication is discarded so as to transmit the sound information to the telephone, and when transmitting the packetized sound information after reception thereof is complete, all packets that are stored in the storage means, including the delay packets, are arranged in a predetermined order so as to transmit the sound information to the telephone. Thus, sound can be reproduced clearly, even if the sound information is difficult to hear during communication where the sound information is reproduced at the same time it is received, and the quality of recorded voice can be improved.

### BRIEF DESCRIPTION OF THE DRAWINGS

Other and further objects, features, and advantages of the invention will be more explicit from the following detailed description taken with reference to the drawings wherein:

FIG. 1 is a diagram showing the connection scheme of telephones connected to the Internet;

FIG. 2 is a block diagram showing the configuration of a telephone 1 of an embodiment of the invention;

FIG. 3 is a block diagram showing the configuration of a cordless child device 2;

FIGS. 4A and 4B are diagrams showing the exterior of the telephone 1 and the cordless child device 2;

FIGS. 5A to 5D are diagrams schematically showing a communication method of the invention.

FIGS. 6A and 6B are diagrams showing the configuration of voice frames and voice packets;

FIGS. 7A and 7B are flowcharts showing a communication process of the invention;

FIGS. 8A to 8D are diagrams showing the modes of the processes for recording and reproducing voice packets;

FIG. 9 is a diagram showing the process for storing voice packets to the storage device 24; and

FIGS. 10A and 10B are diagrams showing the process for recording and reproducing through a home gateway 3 of another embodiment of the invention.

### DETAILED DESCRIPTION OF THE PREFERRED EMBODIMENTS

Now referring to the drawings, preferred embodiments of the invention are described below.

The invention is effective with respect to all communication devices for communicating sound information such as voice or music in packets using an Internet protocol, but is described below with a telephone as the communication device.

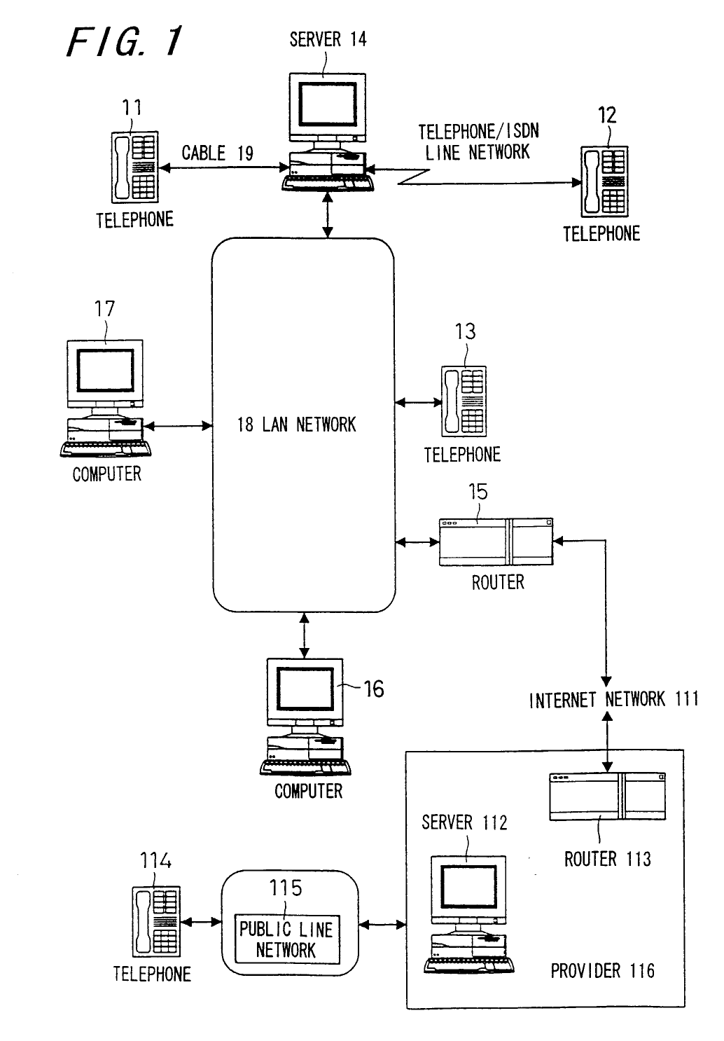

FIG. 1 is a diagram showing the connection scheme of telephones connected to the Internet. A commercial LAN (local area network) used for business is employed in FIG. 1 to illustrate a method of connecting telephones 11, 12, and 13 to an Internet network 111 through a LAN network 18, and a method of connecting a telephone 114 to the Internet network 111 through an Internet Service Provider (abbreviated as ISP or provider) 116, which is generally used when an individual connects to the Internet. In the case of connecting via the LAN network 18, client computers 16 and 17 and the telephone 13 are interconnected over the LAN network 18 and connected to the Internet 111 from the LAN network 18 via a router 15. At the same time, a server 14 is connected to the LAN network 18 and temporarily stores received text data, telephone voice, and data to be transmitted to clients managed by the server 14. In the case of VoIP, however, data is sent directly to the telephone 13 when reproduction of voice in real time is required. This circuit configuration is but one example where telephones are connected to the Internet, and the invention is not limited to this connection of telephones to a data line, which is an example of the present invention. The telephone 11 of FIG. 1 is directly linked to the server 14 via a cable 19. Here, the cable links directly to the server from the parallel I/F of the telephone, so that voice can be reproduced from packets on the telephone side. The telephone 12 is connected to the server 14 through a telephone line or an ISDN line network 110. If the telephone 12 is provided with a device such as a modem with which it can communicate with the server 14 via the line network, or with a device that understands a protocol such as TCP/IP and creates signals, then voice can be reproduced on the telephone side. If the telephone 12 is not provided with such a device, then packets must be converted into voice signals in the server 14.

The telephone 13 is connected via the LAN network 18, and connects to a LAN 215 via a LAN I/F. The LAN does not transfer voice signals, and thus it is necessary that the telephone 13 receives voice as packets and reproduces voice from the packets on the telephone side. The telephone 114 employs a connection scheme ordinarily used when individuals connect to the Internet. A user enters into contract with a provider 116, which is a company that provides Internet access, and is connected to the provider 116 via a public line network 115 such as a telephone line network or an ISDN line network. The provider 116 manages information that is sent/received by the client (the telephone 114, for example) with a server 112 managed by the provider 116, and connects to the Internet 111 via a router 113 to transmit information across the Internet and receive information from the Internet.

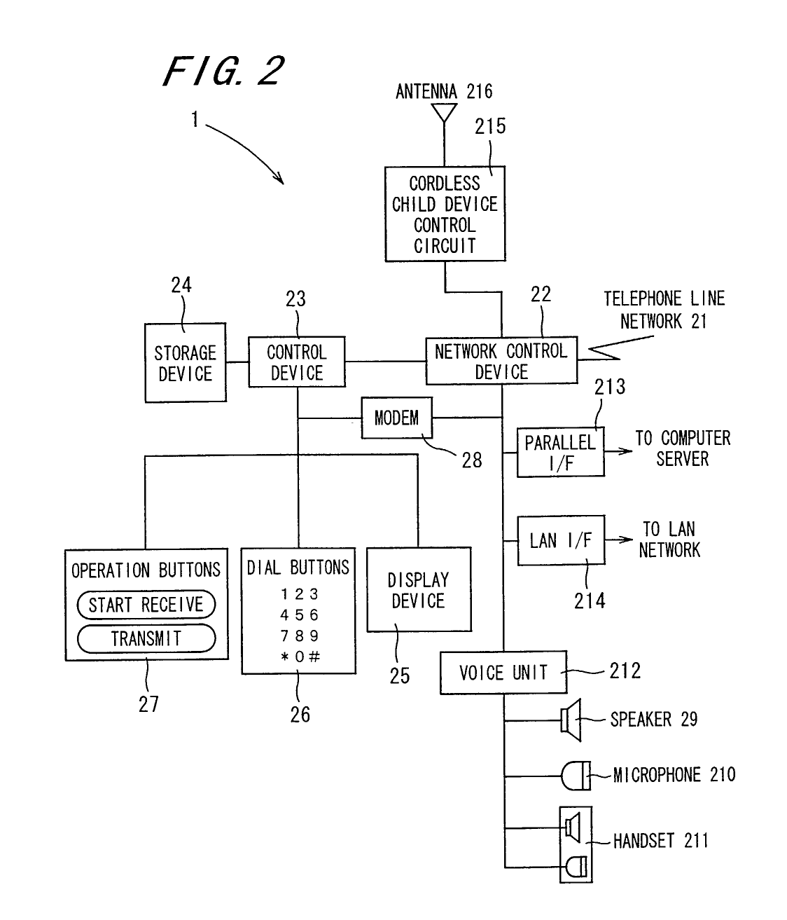

FIG. 2 is a block diagram showing the configuration of a telephone 1 of a first embodiment of the invention. A telephone 1 is a communication device including a network control device 22, a control device 23, a storage device 24, a display device 25, dial buttons 26, operation buttons 27, a modem 28, a speaker 29, a microphone 210, a handset 211, a voice unit 212, a parallel I/F (interface) 213, a LAN I/F 214, a cordless child device control circuit 215, and an antenna 216. The telephone 1 is connected to the telephone line network 21 through the network control device 22. The network control device 22 observes the conditions on the telephone line network 21 and switches the line to the voice unit 212 side or the cordless child device control circuit 215 side. The modem 28 is a modem for a transmission source display service that reads a transmission source number that is sent at 1200 bps, or is a modem for sending/receiving data with respect to the provider 116 or the server 14 of the LAN network 18.

The control device 23, in concert with a program stored in the storage device 24, sets the operation of the entire device based on information input from the operation buttons 27 and the dial buttons 26, information that indicates the condition of each unit of the device, and information such as signals from the telephone line network 21, and supplies commands to the entire device and outputs display instructions to the display device 25. Also, when sound information is converted into voice signals from packets in the telephone 1, it is necessary that the telephone 1 is also provided with the ability to understand TCP/IP and a voice conversion function.

The storage device 24 is storage means for storing voice packets, and includes a receive buffer and a record buffer. The display device 25 is the means through which the telephone 1 displays information to the user, and the various parameters of the telephone 1 can be interactively set using the display device 25, the operation buttons 27, and the dial buttons 26. The voice unit 212 is a device for amplifying voice signals and inputting/outputting voice via the handset 211, the speaker 29, and the microphone 210. Reproduction means includes the control device 23 and the voice unit 212, and reproduces voice packets stored in the receive buffer or the record buffer of the storage device 24 as voice signals and outputs these signals from the speaker 29 or the handset 211.

The dial buttons 26 and the operation buttons 27 are selection means and specification means employed by the user to input information and instructions to the device. The buttons can be used to set whether to use the various functions of in the telephone 1 (including the operation of the reproduction means) and to specify what portion of the sound information stored in the record buffer to reproduce.

The telephone 1 of the invention is capable of wirelessly connecting to a single, or a plurality of, child device(s) via the cordless child device control circuit 215. The cordless child device control circuit 215 includes, for example, a control portion for searching a communication route for connecting to the child device and establishing connections, a compander portion for compressing and expanding signals, and a tuner for transmitting and receiving electromagnetic waves. For example, when a request to communicate with a child device comes from the control device 23, the cordless child device control circuit 215 performs carrier sense of the control channels to search for an open control channel. In the case where a control channel is capable of communication, the ID signal of the parent device using this channel and the ID signal of its child devices are transmitted, the ID signal from each child device is received and confirmed, the open channel for communication is confirmed, the communication channel is specified, and the communication route is set so that a communication route to the child device(s) can be established. When the communication is over, a process for ending communication is performed. Thus, the cordless child device control circuit 215 manages all processes from establishing to ending communication with the child devices.

The voice packets are sent and received by the modem 28, the parallel I/F 213, the LAN I/F 214, and the network control device 22.

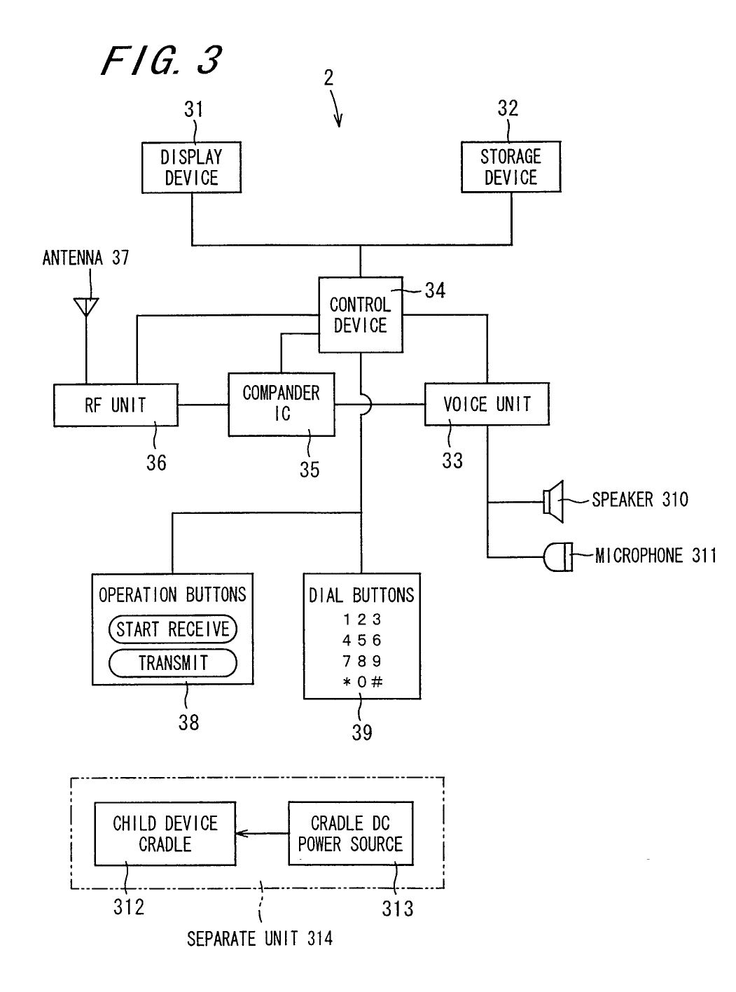

FIG. 3 is a block diagram showing the configuration of a cordless child device 2. The cordless child device 2 includes a display device 31, a storage device 32, a voice unit 33, a control device 34, a compander I/C 35, a RF unit 36, an antenna 37, operation buttons 38, dial buttons 39, a speaker 310, and a microphone 311. It is necessary that each unit of the cordless child device 2 is small in size because the device must be small. The telephone 1, which is the parent device, is connected to the telephone line network 21 via the network control device 22, but the cordless child device 2 performs communication with the telephone 1, its parent device, via wireless communication, and communicates with the outside over the telephone line network 21 via the telephone 1. The packets of sound information are converted into voice in the telephone 1.

The control device 34, in concert with the storage device 32, ascertains the operating state of each portion of the device and executes commands for operation to the units. It is also manages the control of communication with the telephone parent device, and closely communicates with the cordless child device control circuit 215 of the telephone 1 to perform the various operations necessary to establish and terminate the communication route, including confirming the control channels and open communication channels, and confirming and sending the parent device ID and the child device ID. That is, it manages the control operation on the child device side as the party in communication with the cordless child device control circuit 215 of the telephone 1. The compander IC 35 is a circuit that compresses the signals to be sent into a non-linear shape so that speech communication can be carried out clearly regardless of the size of the voice within the frequency band, and also expands and demodulates compressed signals that are received. An amplifier is provided within the voice unit 33, and vocalizes audio through the speaker 310 and amplifies signals that are input from the microphone 311.

The RF unit 36 is a tuner that sends and receives voice and control signals as electromagnetic waves via the antenna 35. The cordless child device 2 is also provided with a separate unit 314 including a child device cradle 312 and a charge DC power source 313 as the cradle power source. The dial buttons 39 and the operation buttons 38 have substantially the same function as the dial buttons 26 and the operation buttons 27 of the telephone 1, and are used to input user telephone numbers, for example. The display device 31 displays information from the cordless child device 2 to the user. In the case of the cordless child device 2 as well, the display device 31, the operation buttons 38, and the dial buttons 39 are used to interactively input data and parameters, for example.

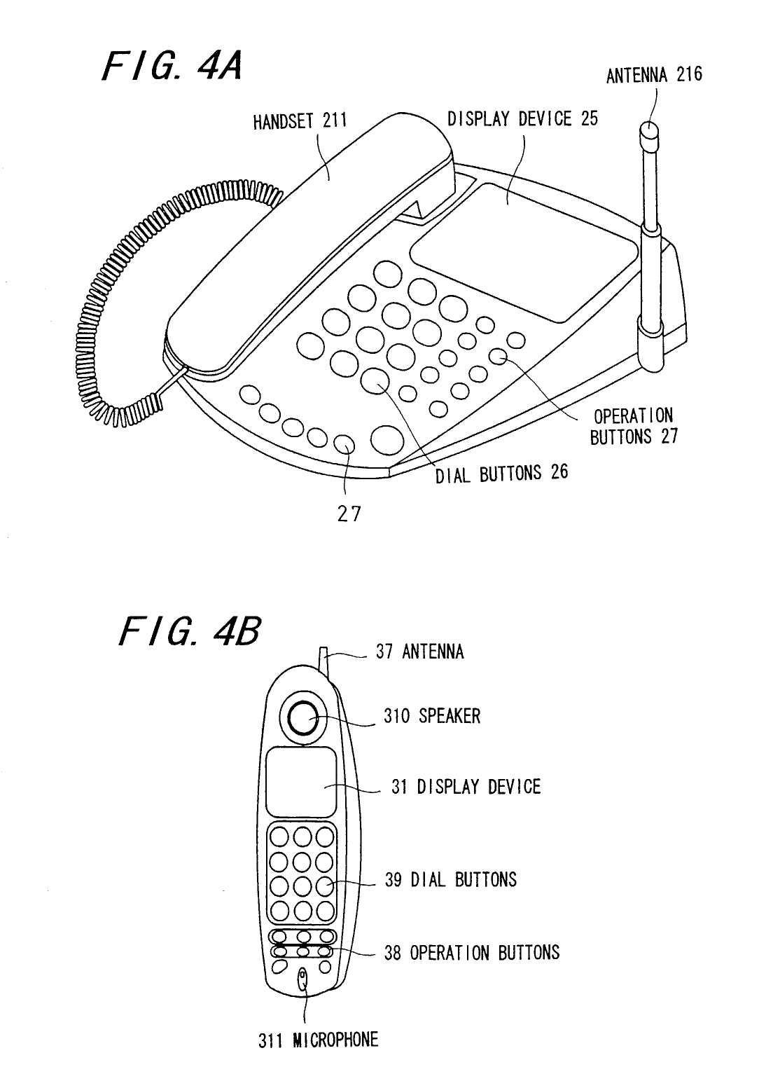

FIGS. 4A and 4B are diagrams showing the external appearance of the telephone 1 and the cordless child device 2. FIG. 4A shows the telephone 1, which is the parent device, and FIG. 4B shows the cordless child device 2. In this embodiment, the parent device has reproduction means for reproducing voice from packets, and the cordless child device 2 can hear the reproduced voice through wireless communication with the parent device. The selection means and the specification means of the invention for selecting whether to perform the reproduction process and for specifying the section to be reproduced, respectively, can also be achieved by the operation buttons 38 and the dial buttons 39 of the cordless child device 2, so that selection and specification can be performed from the cordless child device 2.

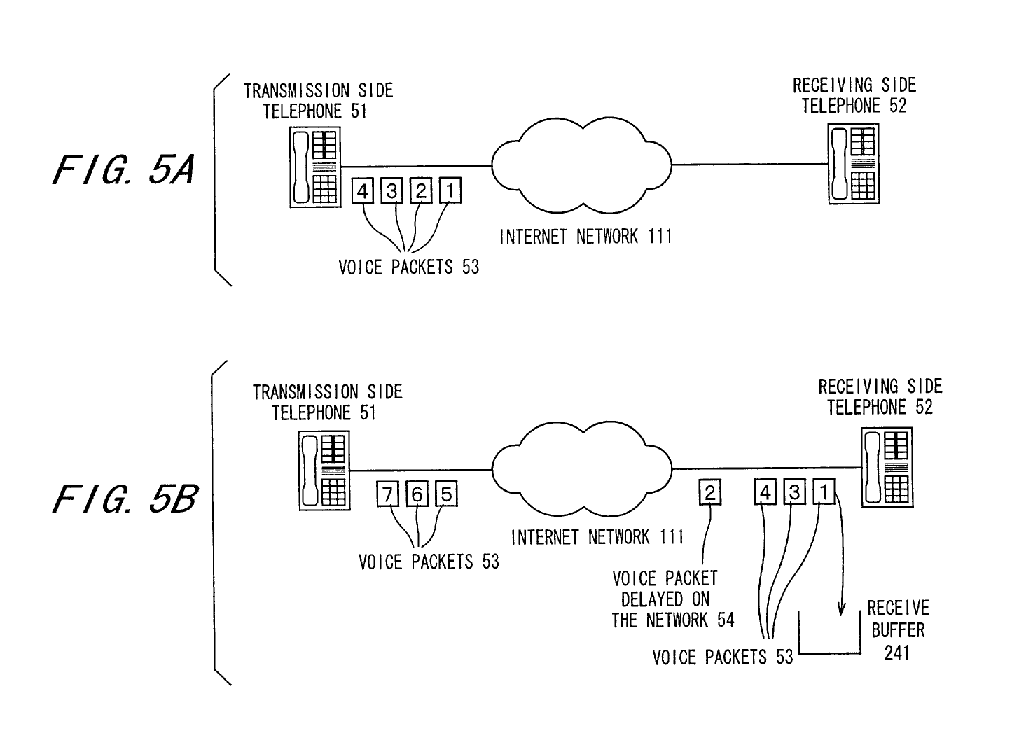

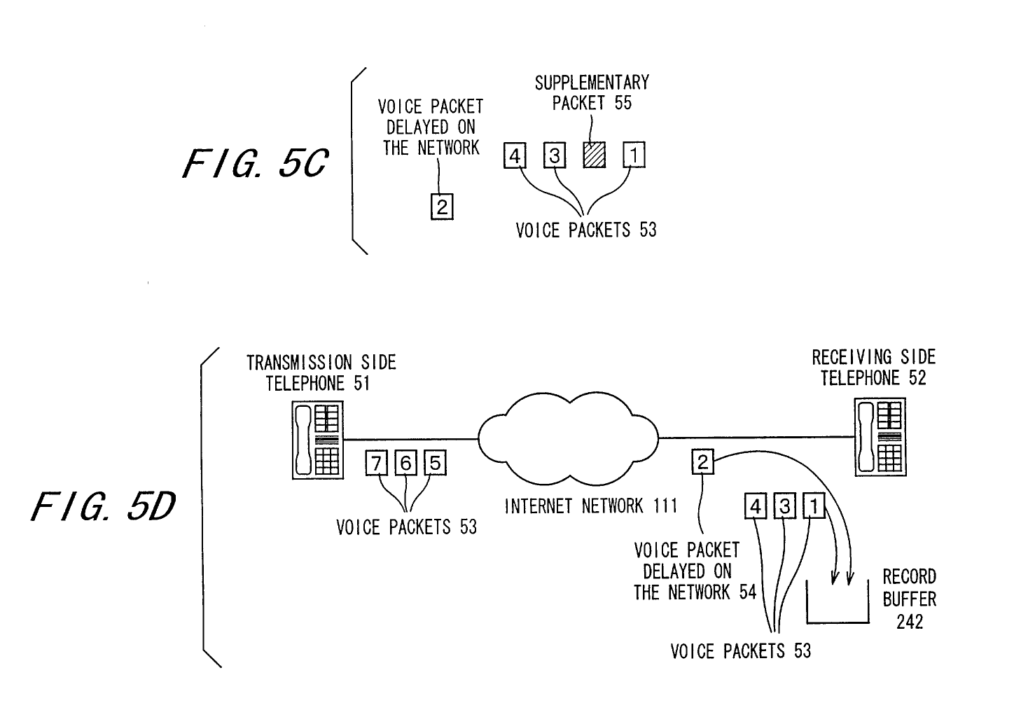

FIGS. 5A to 5D are schematic views of the communication method of the invention. When voice is to be reproduced at the same time it is received, first, as shown in FIG. 5A, when transmission of voice starts, the voice signals from a telephone 51 on the transmitting side are packetized into voice packets 53 and transmitted sequentially. The packets are shown here assigned numbers in order from P1. The voice packets 53 are sent to a telephone 52 on the receiving side via the Internet network 111. Packets are processed in individual units on the Internet network 111, and thus the voice packets that arrive at the telephone 52 on the receiving side may each have a different arrival time. As shown in FIG. 5B, the voice packet P2 has become a delay packet 54 on the network and does not arrive in time for real time voice reproduction, where packets are reproduced as received. The voice packets 53 that arrive in time to be processed are temporarily stored in a receive buffer 241 within the storage device 24 and reproduced in packet order. As shown in FIG. 5C, the delay packet 54 is discarded and not reproduced, and in place of the lost voice packet (in this example, the packet P2), a supplementary packet 55 is created using data extrapolated from the packets before and after the packet P2 and is reproduced.

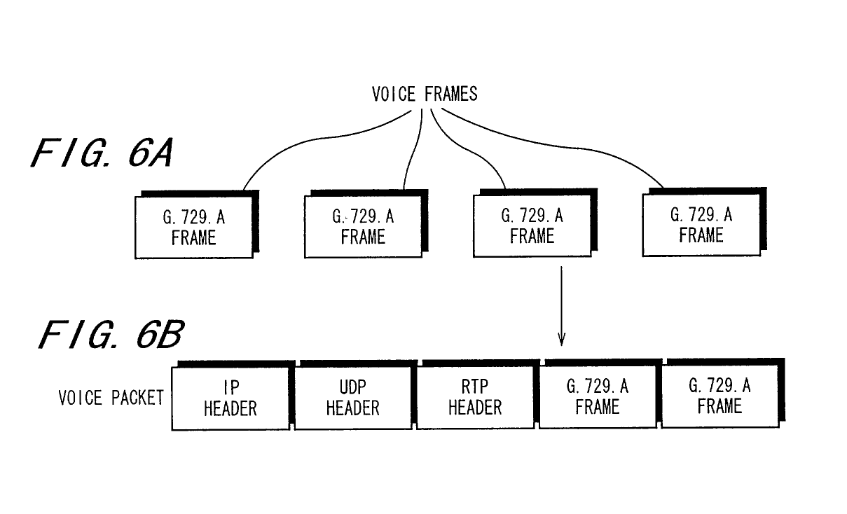

FIGS. 6A and 6B are diagrams showing the configuration of the voice frames and the voice packets. As shown in FIG. 6A, the voice frames are provided as frames at a predetermined time interval (10 ms, for example). The voice frames are generally packetized every 20 ms, and a packet including a plurality of frames may be transmitted with a period of 200 ms as a maximum. As shown in FIG. 6B, the voice packets includes various types of headers and voice frame data. The RTP header includes a description of version information, a time stamp, an identifier, and a sequence number, and the order of the packets is detected on the receiving side from this sequence number.

As shown in FIG. 5D, the packet P2 that was not reproduced is stored in a record buffer 242 of the storage device 24 along with the other packets, so that when reproducing voice after all packets have been completely received, such as in playback, all the received packets are arranged in a predetermined order based on their detected sequence number and reproduced.

Thus, even if voice is deteriorated due to delayed packets, when reproducing in real time, all the packets, including delayed packets, are reproduced during playback, so that the quality is improved and voice can be reproduced more clearly.

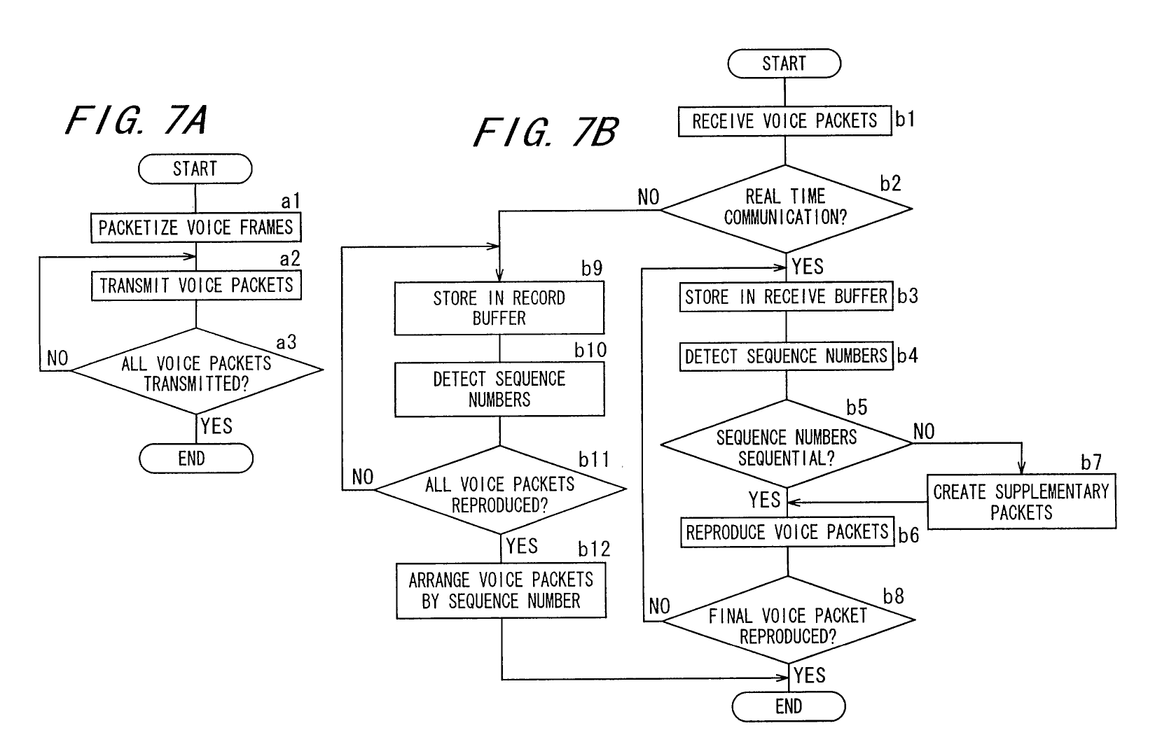

FIGS. 7A and 7B are flowcharts showing the communication process of the invention. FIG. 7A is a flowchart of the telephone 51 on the transmitting side, and FIG. 7B is a flowchart of the telephone 52 on the receiving side. It should be noted that the flowcharts of the diagrams show the processing of a predetermined number of voice frames, for example ten frames. In the telephone 51 on the transmitting side, in step a1, ten voice frames are converted into voice packets like those shown in FIG. 6. In step a2, the voice packets 53 are transmitted sequentially. In step a3, it is determined whether all of the voice packets of ten frames each have been transmitted. In the case where all of the voice packets have been transmitted, the process is ended. In the case where there are still voice packets that have not been transmitted, the procedure returns to step a2.

In the telephone 52 on the receiving side, in step b1, the voice packets 53 are received. Then, in step b2, it is determined whether speech communication is being performed in real time. In the case where the communication is in real time, the procedure advances to step b3. In the case where the communication is not in real time, such as the case of a recorded message, the procedure advances to step b9. In step b3, a plurality of voice packets are stored in the receive buffer 241. In step b4, the sequence number of each voice packet in the receive buffer 241 is detected. In step b5, it is determined whether the sequence numbers of the voice packets in the receive buffer 241 are sequential. In the case where the sequence numbers are sequential, the procedure advances to step b6 and the voice packets are reproduced sequentially. In the case where the sequence numbers are non-sequential because, for example, a delay voice packet 54 was generated on the network, the procedure advances to step b7, and using data extrapolated from the voice packets before and after the delayed packet, the supplementary packet 55 is created. In step b8, it is determined whether the final voice packet of the voice packets of ten frames each has been received. In the case where the final voice packet has been received, the process is ended. In the case where the final voice packet has not been received, the procedure returns to step b3.

In the case where the speech communication is not in real time, in step b9, the plurality of voice packets are stored in the record buffer 242. In step b10, the sequence number of each voice packet in the record buffer 242 is detected. In step b11, it is determined whether all voice packets of ten frames each have been received. In the case where all voice packets have been received, the procedure advances to step b12, and in the case where there are packets that have not been received, the procedure returns to step b9. In step b12, the voice packets are arranged so that their sequence numbers are sequential and then stored, and the process is ended. When reproducing voice packets that have been recorded, all of the voice packets are reproduced in sequence number order, so that voice can be reproduced in greater clarity.

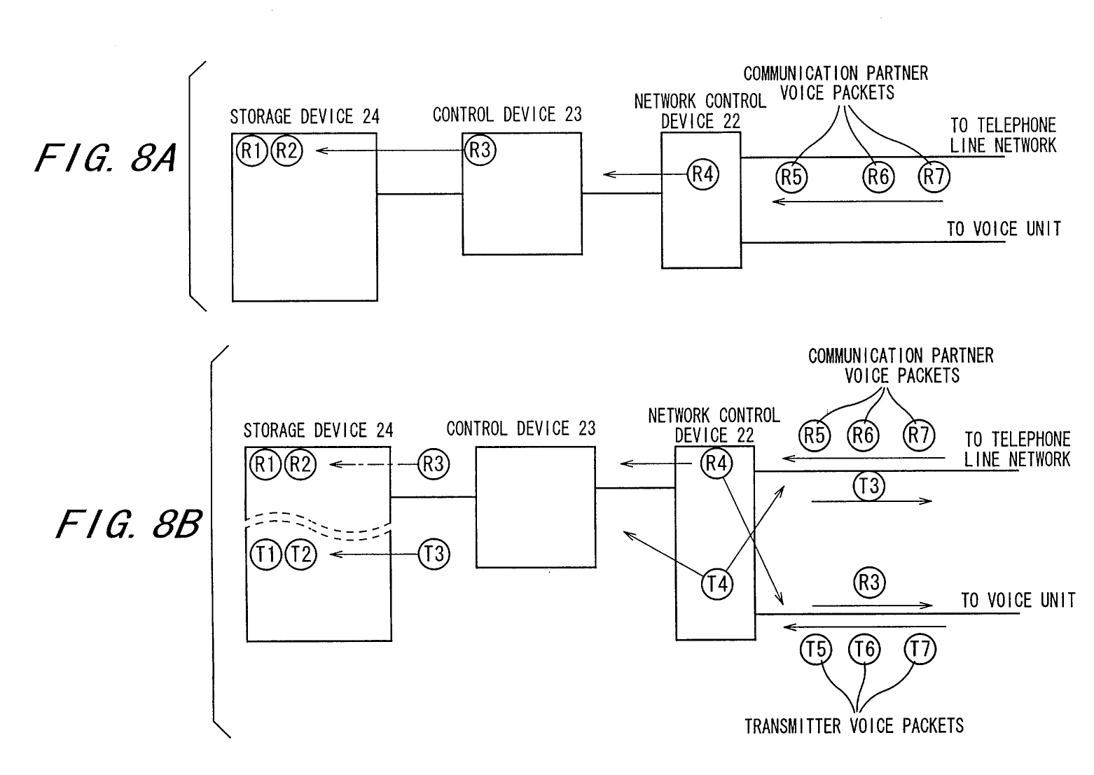

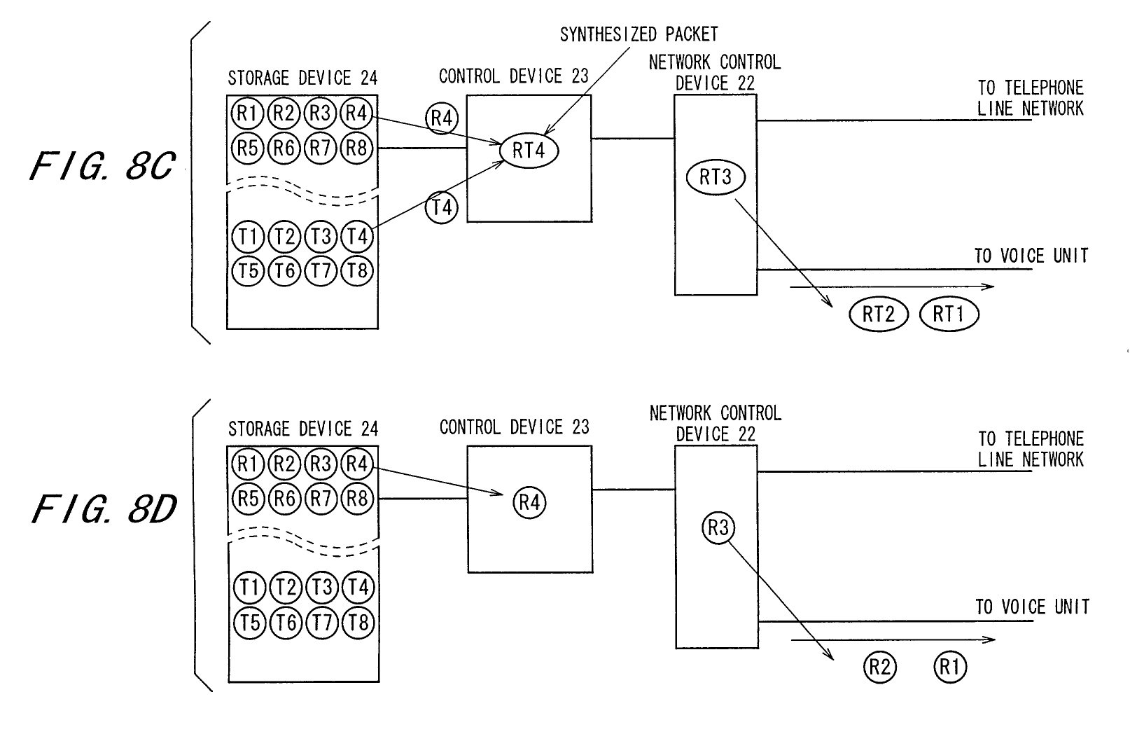

FIGS. 8A to 8D are diagrams showing the modes of the processes for recording and reproducing voice packets. The recording process is described first. The recording process includes the message recording mode shown in FIG. 8A and the speech communication recording mode shown in FIG. 8B. In the message recording mode, voice packets (R1, R2, etc.) from the communication partner side are received by the network control device 22 from the telephone line network 21, and the control device 23 stores them in the storage device 24. In the speech communication recording mode, the communication partner side voice packets are received by the network control device 22 from the telephone line network 21 and sent to both the voice unit 212 and the control device 23. The communication partner side voice packets are output as voice from the speaker 29 or the handset 211 via the voice unit 212 and also stored in the storage device 24. Voice packets (T1, T2, etc.) from the receiving side are made of voice that is input through the microphone 210 or the handset 211 and packetized by the voice unit 212, and are sent to the network control device 22. The network control device 22 sends the receiving side voice packets to the telephone line network 21 and the control device 23 to transmit them to the communication partner side telephone and store them in the storage device 24.

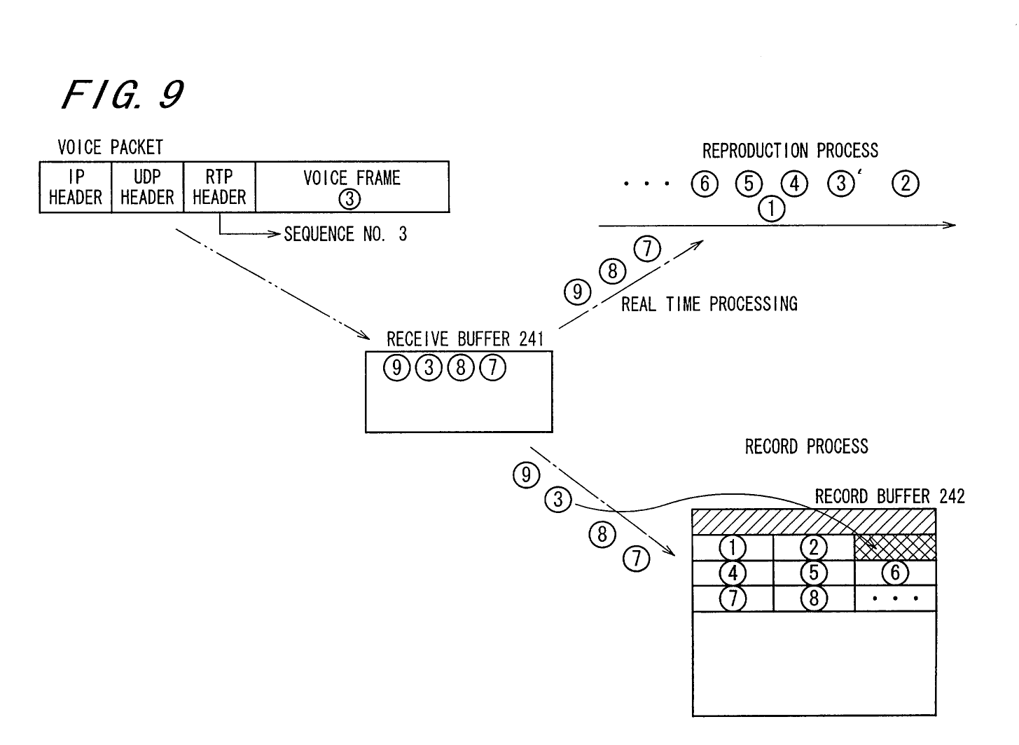

FIG. 9 shows the process for storing the voice packets in the storage device 24. FIG. 9 shows the process in the case where the voice packet of sequence number 3 has become a delayed packet. The voice packet of sequence number 3 is delayed and is received at the receive buffer 241 between the voice packets of sequence number 8 and 9. In real time reproduction, the delayed packet is discarded and not reproduced, and a replacement packet such as noise is reproduced in its place. When recording, however, packet reproduction is performed after all packets have been received, so that a space the size of the voice packet of sequence number 3 is left open in the record buffer 242 between the voice packets of sequence number 2 and 4, and the moment the voice packet of sequence number 3 is received it is stored in that open space. Consequently, when reproducing voice that has been recorded, all packets can be reproduced in sequence number order.

The reproduction process is described next. The reproduction process includes the conversation reproduction mode shown in FIG. 8C and the other party voice reproduction mode shown in FIG. 8D. In the conversation reproduction mode, the control device 23 synthesizes the communication partner side voice packets and the receiving side voice packets that are stored in the storage device 24 and outputs the result to the network control device 22. The synthesized packets (RT1, RT2, etc.) are sent to the voice unit 212 by the network control device 22 and output as voice from the speaker 29 or the handset 211. In the other party voice reproduction mode, the control device 23 sends the communication partner side voice packets that are stored in the storage device 24 to the network control device 22. The communication partner side voice packets are sent to the voice unit 212 by the network control device 22 and output as voice from the speaker 29 or the handset 211.

The voice packets are stored in sequence number order, as shown in FIG. 9, so that high quality voice without breaks or noise can be reproduced.

Also, in the invention, the received voice packets are stored in predetermined blocks, and blocks are specified at the time of reproduction, so that only portions that are desirable to reproduce can be reproduced. As one method for turning the voice packets into blocks, the voice from the other party side and the voice from the receiving side are observed separately, and in each side, voice up to a point where the voice has been silent for a fixed period of time is turned into a single block. Alternatively, the other party side and receiving side voices are observed separately to detect silent portions and turned into blocks, but in this case, voices are turned into blocks when voice is detected from the receiving or other party sides after silence has been detected on the other party or receiving sides, respectively.

During reproduction, in the case where the user wishes to reproduce a portion before or after the portion that is currently being reproduced, the user can do so by performing an operation to skip only over blocks that the user would like to skip for reproduction. Also, it is possible to start reproduction from a portion that has been skipped to by a specified number of blocks by performing the operation prior to reproduction.

Also, with this invention, the received voice packets can be stored at a predetermined time, and when reproducing the voice packets, the time can be specified so as to reproduce only a desired portion.

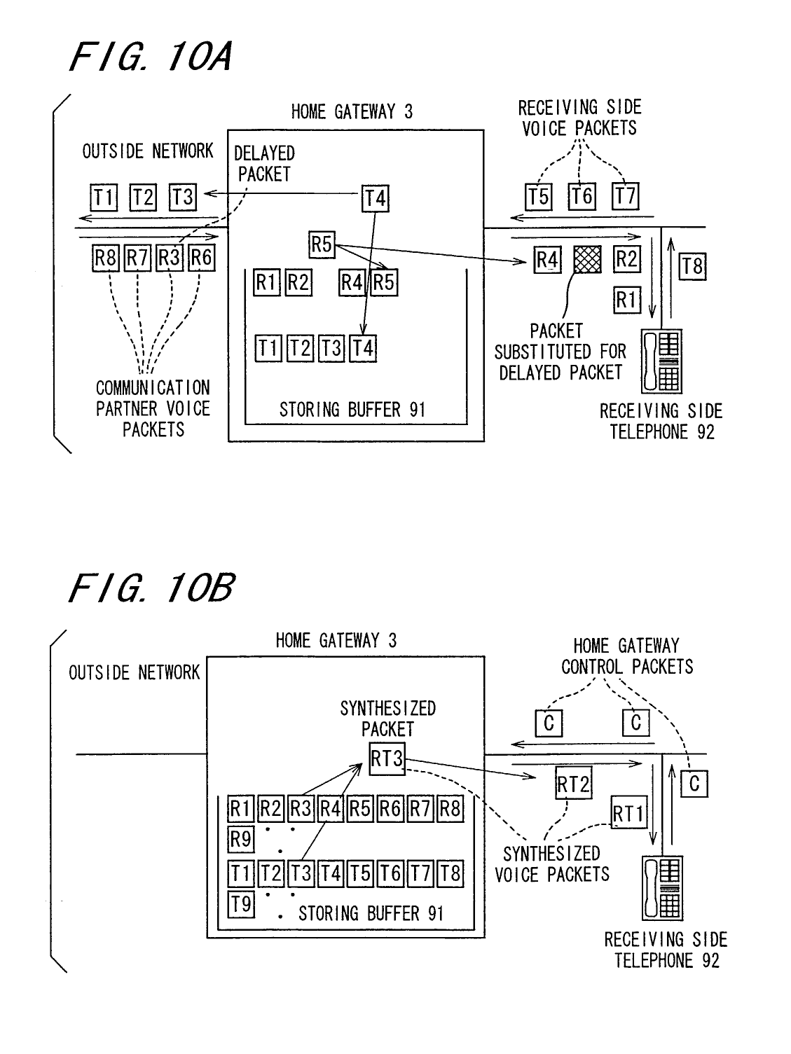

FIGS. 10A and 10B are diagrams illustrating another embodiment of the invention, in which recording and reproduction are performed through a home gateway 3. The home gateway 3 corresponds to the server 14 of FIG. 1, and is a communication terminal that links communication instruments and electronic appliances within a home via LAN within the home and performs communication acting as a gateway to outside networks. FIG. 10A illustrates the process for recording during speech communication. When communication partner side voice packets (R1, R2, etc.) delivered via an outside network are received by the home gateway 3, the communication partner side voice packets are copied and stored in a holding buffer 91 in order. Also, the communication partner side voice packets that arrive are transmitted to a telephone 92 on the receiving side.

When a packet delay occurs, an area for storing the delayed packet R3 is kept open on the home gateway 3 and the subsequent packet is stored in the holding buffer 91, and a packet 93 is sent to the telephone 92 on the receiving side as a substitute for the delayed packet. In the case where a delayed packet 95 arrives, it is stored in the area held open in the holding buffer 91 and is not sent to the telephone 92 on the receiving side.

Also, receiving side voice packets (T1, T2, etc.) that are transmitted from the telephone 92 on the receiving side are also copied by the home gateway 3 and stored in the holding buffer 91, and simultaneously transmitted to the outside network.

FIG. 10B illustrates the reproduction process. For reproduction of recorded voice, a reproduction operation is performed in the telephone 92 on the receiving side to send home gateway control packets (C) to the home gateway 3. The home gateway control packets are received by the home gateway 3, and voice packets (RT1, RT2, etc.) are generated by synthesizing the communication partner side voice packets and the receiving side voice packets that are stored in the holding buffer 91 and sent to the telephone 92 on the receiving side. With the telephone 92 on the receiving side, the user can reproduce the recorded voice by reproducing the synthesized voice packets that are received.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A communication method for communicating sound information in packets using an Internet protocol, the communication method comprising the steps of:
when reproducing packetized sound information simultaneously with reception thereof, discharging a delay packet that is delayed during speech communication and reproducing the sound information, and
when reproducing the packetized sound information after reception thereof, arranging all received packets including the delay packet, in a predetermined order so as to reproduce the sound information.

2. A communication apparatus for communicating sound information in packets using an Internet protocol, the communication apparatus comprising:
storage means for storing packets of sound information that are received; and
reproduction means for discarding a delay packet that is delayed during communication and reproducing the sound information, when reproducing the packetized sound information simultaneously with reception thereof, and for arranging all packets that are stored in the storage means, including the delay packet, in a predetermined order and reproducing sound information, when reproducing the packetized sound information after reception thereof.

3. The communication apparatus of claim 2, further comprising:
selection means for selecting whether to operate the reproduction means by a user.

4. The communication apparatus of claim 2, further comprising:
specification means for specifying by a user, during reproduction of sound information simultaneous with reception thereof, or after reproduction thereof, a portion of the packets stored in the storage means to be arranged in a predetermined order for reproduction.

5. The communication apparatus of claim 3, further comprising:
specification means for specifying by a user, during reproduction of sound information simultaneous with reception thereof, or after reproduction thereof, a portion of the packets stored in the storage means to be arranged in a predetermined order for reproduction.

6. The communication apparatus of claim 4, wherein the storage means stores received sound information in predetermined blocks, and the specification means specifies the block.

7. The communication apparatus of claim 5, wherein the storage means stores received sound information in predetermined blocks, and the specification means specifies the block.

8. The communication apparatus of claim 4, wherein the storage means stores received sound information at predetermined times, and the specification means specifies the time.

9. The communication apparatus of claim 5, wherein the storage means stores received sound information at predetermined times, and the specification means specifies the time.

10. A communication terminal connected to a telephone and communicating sound information in packets using an Internet protocol, comprising:
storage means for storing packets of sound information that are received; and
transmission means for discarding a delay packet that is delayed during communication and transmitting the sound information to the telephone, when transmitting the packetized sound information simultaneously with reception thereof, and for arranging all packets that are stored in the storage means, including the delay packet, in a predetermined order and transmitting the sound information to the telephone, when transmitting the packetized sound information after reception thereof.
